(19) United States
(12) Patent Application Publication
(10) Pub. No.: US 2017/0175060 A1
(43) Pub. Date: Jun. 22, 2017

(54) Vodka Bottle

(71) Applicant: Jhordan Stevenson, Vancouver (CA)

(72) Inventor: Jhordan Stevenson, Vancouver (CA)

(21) Appl. No.: 15/384,541

(22) Filed: Dec. 20, 2016

Related U.S. Application Data
(60) Provisional application No. 62/270,092, filed on Dec. 21, 2015.

(51) Int. Cl. C12H 1/044; C12G 3/08; B65D 85/72; A44C 5/00; B65D 1/02; B65D 23/14

(52) U.S. Cl. CPC C12H 1/0408; B65D 1/0223; B65D 23/14; B65D 85/72; A44C 5/0007; C12G 3/08

(57) ABSTRACT

The invention relates to a vodka bottle which is preferably made of glass materials. The vodka bottle comprises an oval top portion. The invention comprises a metal band which is used for advertising and the user can also use the metal band as a wearable bracelet. The activated carbon balls inside the vodka bottle distill and purify the alcoholic beverage.

### TECHNICAL FIELD

Embodiments described herein relate to a vodka bottle and more particularly to an easily usable and portable bottle which can be used for storing and serving beverages. More particularly the embodiments relate to a vodka bottle with unique structure and characteristics. Further, the embodiments also describe various characteristics and features of a partially transparent Vodka Bottle relating to easy use, portability and holdability. Further the embodiments also describe an advertising feature of the partially transparent vodka bottle.

### BACKGROUND

Generally alcoholic and other beverages are stored in bottles which are strong enough to carry them and protect the beverage from sun and other weather changes. The bottles carrying alcoholic beverages are normally too rigid at the neck portion and hence they are not much designed in a way to be used very easily and without extra care. Once the alcoholic beverages are stored inside a bottle it cannot be distilled and filtered inside the bottle, which may affect the quality of the beverage.

Further, the bottles or containers used for storing alcoholic beverages are transparent in nature and made of glass materials. The design and artistic feature of a bottle plays a major role in attracting the user. The convenient pouring of the alcoholic beverages is another feature of a bottle which attracts the user. Some bottles are not easy to hold by the user because of their structure and shape. Further the bottles are usually made of glass which is not always ideal for advertisements to attract the user. There is a need to provide such a bottle for alcoholic beverages which is easy to handle and use by a user and which is also convenient for advertisements.

### SUMMARY

An object of the present invention is to provide a vodka bottle.

An object of the present invention is to provide a transparent vodka bottle with unique design.

A further object of the present invention to provide a transparent vodka bottle with features for attractive advertisement.

A further object of the present invention is to provide a vodka bottle which is easy to handle and use.

A further object of the present invention is to provide a transparent vodka bottle which comprises activated carbon balls that distills and purify the alcoholic beverage while stored inside the vodka bottle.

### BRIEF DESCRIPTION OF THE DRAWINGS

The foregoing summary, as well as the following detailed description of various embodiments, is better understood when read in conjunction with the drawings provided herein. For the purposes of illustration, there is shown in the drawings exemplary embodiments; however, the presently disclosed subject matter is not limited to the specific methods and instrumentalities disclosed.

FIG. 1 is an illustration of the perspective view of a vodka bottle.

FIG. 2 is an illustration of the front view of the vodka bottle.

FIG. 3 is an illustration of the rear view of the vodka bottle.

FIG. 4 is an illustration of the side view of the vodka bottle.

FIG. 5 is an illustration of another side view of the vodka bottle.

FIG. 6 is an illustration of the bottom plan view of the vodka bottle.

FIG. 7 is an illustration of the top plan view illustrating the upper oval shaped tip of the vodka bottle.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies.

It is to be understood that both the foregoing general description and the following detailed description are exemplary and explanatory only, and are not restrictive of the invention, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements and components comprising one unit and elements or components that comprise more than one unit unless specifically stated otherwise.

The above noted and other objects, in one aspect, may be achieved by a method or a system of the present disclosure. The system includes a vodka bottle which comprises different unique portions and parts of the bottle with novel features.

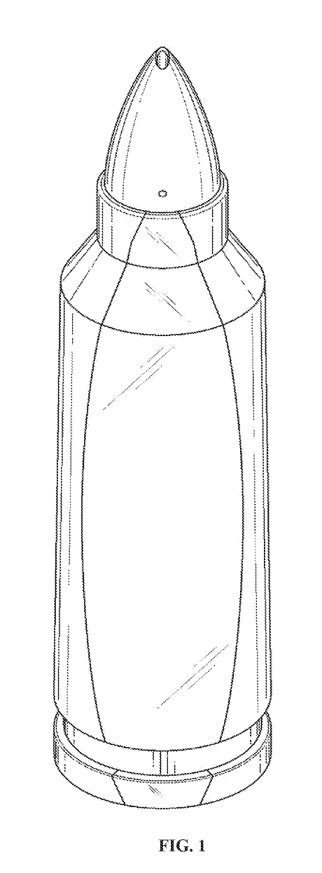

FIG. 1 is an illustration of the perspective view of a vodka bottle. The vodka bottle as illustrated in 1 is preferably partially transparent in appearance whereas it can also be non-transparent and available in different colors and materials. The illustrated vodka bottle herein is preferably made of glass materials wherein the bottle can also be manufactured of different suitable materials.

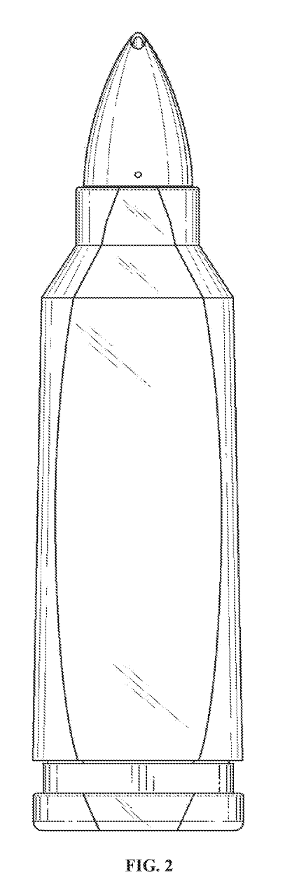

FIG. 2 is an illustration of the front view of the vodka bottle. FIG. 2 illustrates the front view of the bottle which comprises the complete bottle with an opening on the upper portion of the bottle at the tip of the upper portion. The opening at the tip of the bottle provides a passage for the stored beverages to come out as per user's requirements.

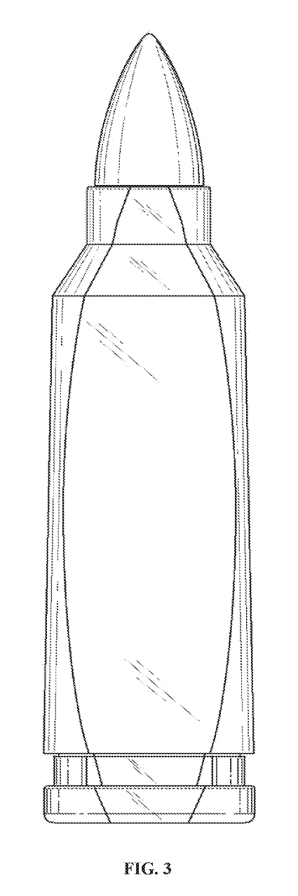

FIG. 3 is an illustration of the rear view of the vodka bottle.

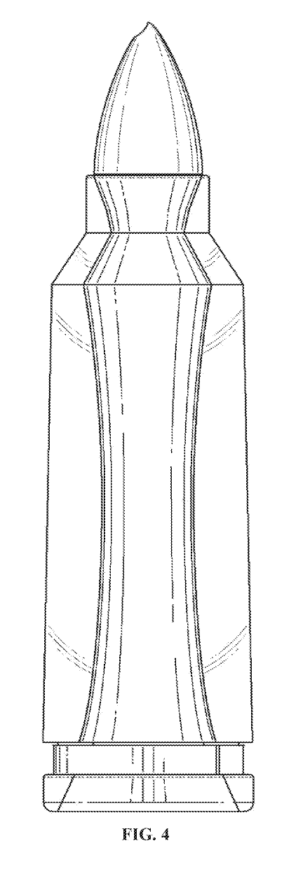

FIG. 4 is an illustration of the side view of the vodka bottle

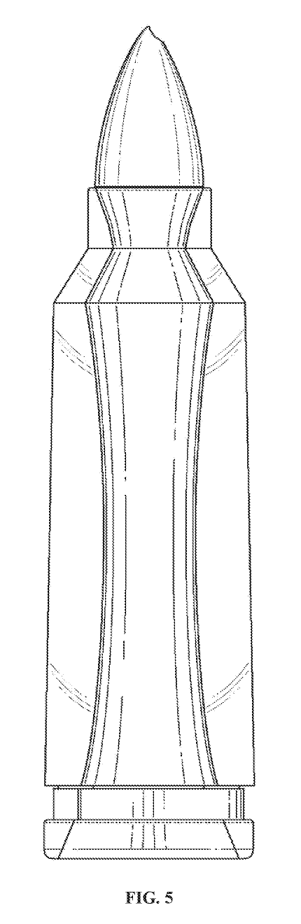

FIG. 5 is an illustration of another side view of the vodka bottle.

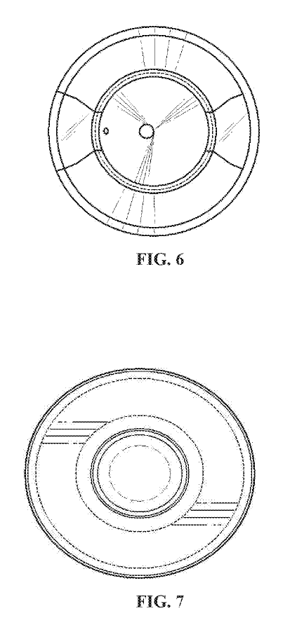

FIG. 6 is an illustration of the bottom plan view of the vodka bottle.

FIG. 7 is an illustration of the top plan view of the vodka bottle. Further FIG. 7 illustrates the upper oval shaped tip of the vodka bottle.

The vodka bottle comprises an upper portion wherein there is an open tip for accessing the stored beverage inside the bottle. The bottle comprises a shape which is easy to handle and convenient to use by the user. The upper portion of the vodka bottle wherein the open tip is situated is oval in shape and is easy to pour beverages by the user. The unique design of the vodka bottle prevents wastage of the beverage while pouring from the bottle.

The vodka bottle comprises a metal band around the base of the bottle wherein advertisements can be done. The aesthetic feature of the bottle attracts the user. The metal band around the base of the vodka bottle is detachable and wearable in hand by the user. The user may use the metal band as a bracelet.

The vodka bottle comprises activated carbon balls which are placed inside, at the bottom of the bottle. The activated carbon balls actively distill and filter the alcoholic beverages when stored in the bottle. The feature relating to the activated carbon balls inside the bottle helps in maintaining the purity and quality of the stored alcoholic beverages.

The present system possesses unique features and characteristics like easy to handle and convenient to use, unique metal band which can be used for advertisements and also can be used as a bracelet by the user. Another unique feature of the present invention is that it comprises activated carbon balls which help in distilling and maintaining the purity and quality of the alcoholic beverages.

In one of the preferred embodiment, the vodka bottle comprises a top oval portion, preferably transparent body, a lower bottom portion, a metal band portion at the base and activated carbon balls.

In one of the preferred embodiment, the vodka bottle comprises top oval portion wherein a hole is provided at the tip for pouring the alcoholic beverages.

In one of the preferred embodiment, the vodka bottle is preferably transparent in appearance.

In one of the preferred embodiment, the vodka bottle may preferably be made of glass materials.

In one of the preferred embodiment, the vodka bottle comprises a lower bottom portion at the base for portability of the bottle.

In one of the preferred embodiment, the vodka bottle comprises a metal band at the base portion of the bottle which is used for advertisements.

In one of the preferred embodiment, the metal band is detachable from the bottle and is capable of being used as a bracelet by the user.

In one of the preferred embodiment, the vodka bottle comprises activated carbon balls inside the bottle for distilling and purifying the alcoholic beverages.

In one of the preferred embodiment, the vodka bottle comprises unique features and is easy to handle and convenient to use by the user.

What is claimed is:

1. A vodka bottle, wherein the vodka bottle comprises:
a. a top oval portion,
b. a preferably transparent body,
c. a lower bottom portion,
d. a metal band portion, and
e. activated carbon balls.

2. The vodka bottle as claimed in claim 1, wherein the top oval portion has a hole provided at the tip for pouring alcoholic beverages.

3. The vodka bottle as claimed in claim 1, wherein the vodka bottle is preferably transparent in appearance.

4. The vodka bottle as claimed in claim 1, wherein the vodka bottle may be preferably made of glass materials.

5. The vodka bottle as claimed in claim 1, wherein the lower bottom portion at the base is provided for enhancing portability of the bottle.

6. The vodka bottle as claimed in claim 1, wherein the metal band at the base portion of the bottle is used for advertisements.

7. The vodka bottle as claimed in claim 1, wherein the metal band is detachable from the bottle and is capable of being used as a bracelet by a user.

8. The vodka bottle as claimed in claim 1, wherein the activated carbon balls are provided inside the bottle for distilling and purifying alcoholic beverages.

9. The vodka bottle as claimed in claim 1, wherein the vodka bottle comprises unique features and is easy to handle and convenient to use by users.
